(19) United States
(12) Patent Application Publication
(10) Pub. No.: US 2019/0070575 A1
(43) Pub. Date: Mar. 7, 2019

(54) Method and Apparatus for Mixing Proppant-Containing Fluids

(71) Applicant: Halliburton Energy Services, Inc., Houston, TX (US)

(72) Inventors: Jim Basuki Surjaatmadja, Du, OK (US); Timothy Holiman Hunter, Duncan, OK (US); Stanley Vernon Stephenson, Duncan, OK (US); Bryan John Lewis, Duncan, OK (US); Calvin Lynn Stegemoeller, Duncan, OK (US); Austin Carl Schaffner, Duncan, OK (US); Bryan Chapman Lucas, Duncan, OK (US)

(73) Assignee: Halliburton Energy Services, Inc., Houston, TX (US)

(21) Appl. No.: 16/083,466

(22) PCT Filed: May 6, 2016
(86) PCT No.: PCT/US2016/031282

§ 371 Date: Sep. 7, 2018

(51) Int. Cl. B01F 13/10; B01F 15/02; B01F 3/12; B01F 5/04; B01F 7/08; B01F 7/24

(52) U.S. Cl. CPC B01F 13/103; B01F 15/0243; B01F 3/1221; B01F 3/1271; B01F 5/0463; C09K 8/80; B01F 7/241; B01F 7/248; B01F 2003/1257; B01F 2013/1052; B01F 7/082

(57) ABSTRACT

Methods and apparatus are disclosed for mixing proppant and other solids with one or more fracturing fluids to form a fracturing slurry, and for delivering the fracturing slurry to a wellbore. In the example systems as described herein, the proppant is mixed with the fracturing fluids through an assembly that limits the number of pumps that are required to move the relatively abrasive proppant]containing fluids. Additionally, in the example systems, the proppant is mixed within enclosed structures, thereby minimizing the escape of dust and other particulates into the surrounding atmosphere and onto the equipment at the well site.

### BACKGROUND

The present disclosure relates generally to methods and apparatus for mixing proppant-containing fluids and for delivering the mixed fluids with proppant to a wellbore; and more specifically relates, in some embodiments, to systems to perform the mixing; and also, in some embodiments, to systems which minimize the impact of pumping and mixing proppant-containing fluids on equipment at the well site.

In the course of completion or remediation of oil and gas wells, fracturing operations are often performed by pumping a fracturing slurry under high pressures that are sufficient to create fractures in the oil or gas-bearing formations, with sand or another solid proppant used in the fracturing slurry to prevent closure of the created fractures once the fracturing pressures are removed. The use of proppants and other solids in performing such fracturing operations, and particularly the mixing and transporting of such solids and/or the fluids containing the solids can be hard on the equipment used to perform the mixing and transporting. For example, in conventional systems in which banks of pumps are used to pressurize a proppant slurry for transport down the wellbore at a selected pressure, the pumps can experience substantial wear as a result of the proppant and other solids in the slurry acting as abrasives within the pumps. Additionally, in the course of transporting the proppant from a proppant container at the well site and to its delivery into the wellbore, many conventional systems allow dust and other abrasives from the proppant and other solids can escape into the air and onto other equipment at the well site.

### BRIEF DESCRIPTION OF THE DRAWINGS

FIG. 1 is a schematic representation of an example fracturing fluid mixing and delivery system in accordance with the present disclosure.

FIG. 2 is a side view representation of an example proppant storage and conveyor system that may be used in the fracturing fluid mixing and delivery system of FIG. 1.

FIG. 3A is a side view, partially in vertical section, depiction of an example-mixing unit as may be used in the system of FIG. 1; and FIG. 3B is a schematic depiction from a top view of an alternative embodiment of a mixer that may be used in the system of FIG. 1.

FIG. 4A-B are each side views, each partially in vertical section, in which FIG. 4A depicts an in-line mixer for use in a system such as that of FIG. 1; and FIG. 4B depicts the in-line mixer of FIG. 4A in an operating position within a conduit.

### DETAILED DESCRIPTION

The present disclosure describes new methods and apparatus for mixing proppant and other solids with one or more fracturing fluids to form a fracturing slurry, and for delivering the fracturing slurry to a wellbore. In the example systems as described herein, the proppant is mixed with the fracturing fluids through an assembly that minimizes the pumps that are required to move the relatively abrasive proppant-containing fluids. Additionally, in the example systems the proppant is mixed within enclosed structures, thereby minimizing the escape of dust and/or other particulates into the surrounding atmosphere and onto the equipment at the well site.

The following detailed description describes example embodiments of the new apparatus for mixing the proppant and other solids to form a fracturing slurry in reference to the accompanying drawings, which depict various details of examples that show how the disclosure may be practiced. The discussion addresses various examples of novel methods, systems and apparatus in reference to these drawings, and describes the depicted embodiments in sufficient detail to enable those skilled in the art to practice the disclosed subject matter. Many embodiments other than the illustrative examples discussed herein may be used to practice these techniques. Structural and operational changes in addition to the alternatives specifically discussed herein may be made without departing from the scope of this disclosure.

In this description, references to “one embodiment” or “an embodiment,” or to “one example” or “an example” in this description are not intended necessarily to refer to the same embodiment or example; however, neither are such embodiments mutually exclusive, unless so stated or as will be readily apparent to those of ordinary skill in the art having the benefit of this disclosure. Thus, a variety of combinations and/or integrations of the embodiments and examples described herein may be included, as well as further embodiments and examples as defined within the scope of all claims based on this disclosure, as well as all legal equivalents of such claims.

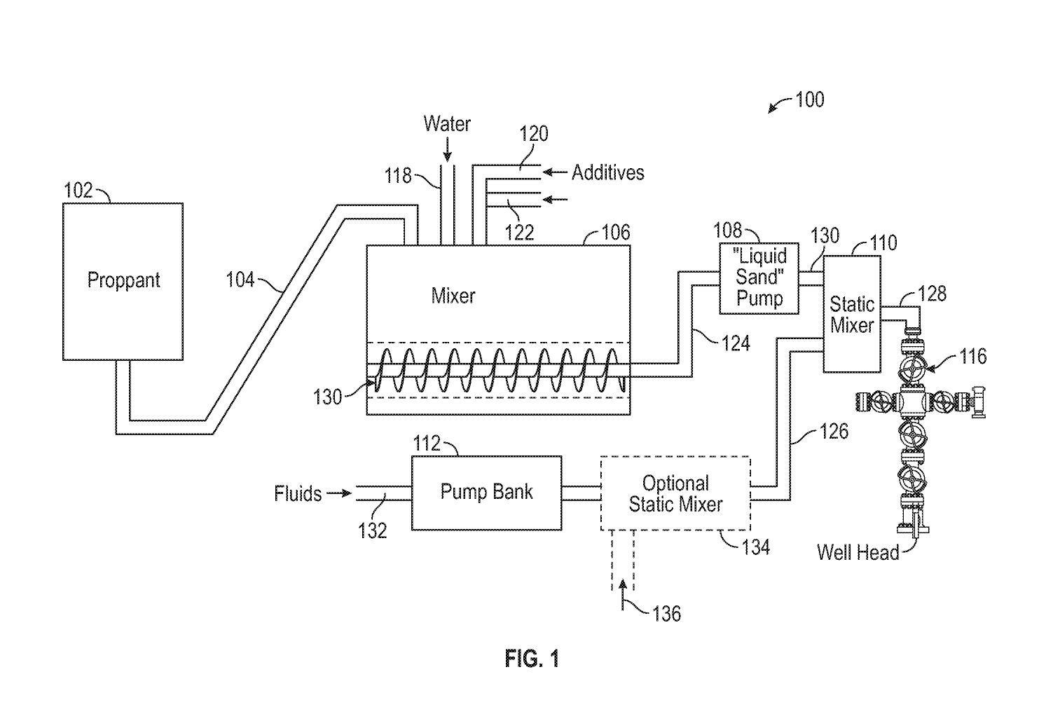

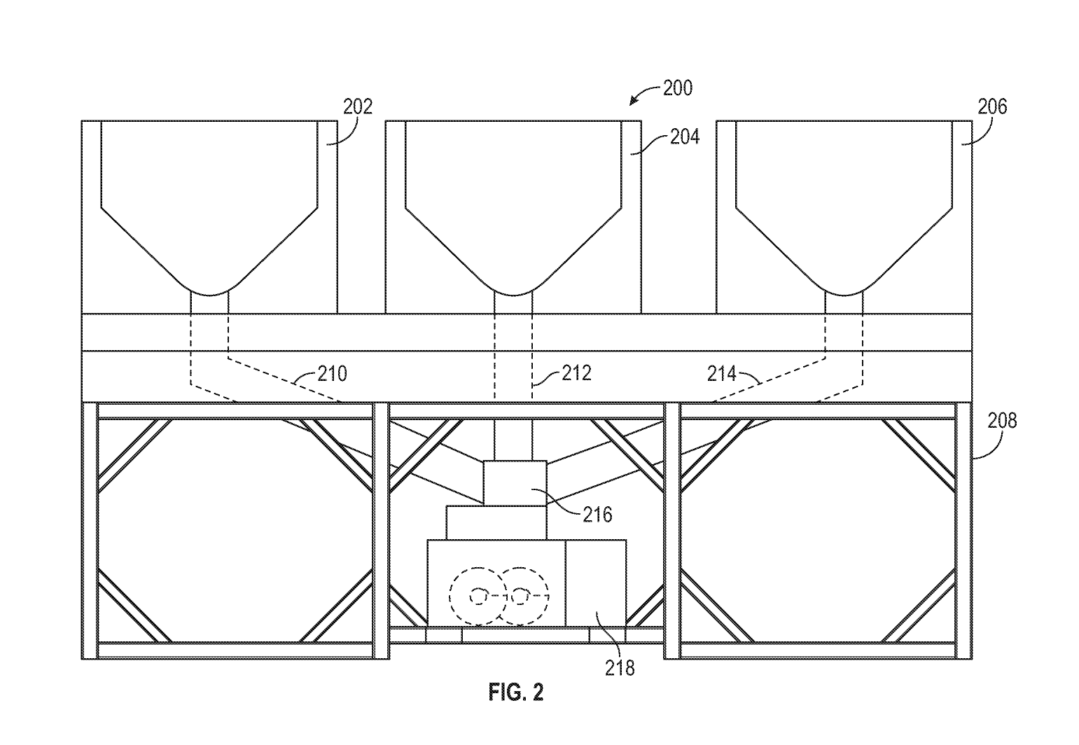

Referring now FIG. 1, that figure schematically depicts an example fracturing fluid mixing and delivery system 100. Mixing and delivery system 100 includes a proppant storage assembly 102. Proppant storage assembly 102 is configured to receive proppant or other solids, such as may be stored and delivered in bins, and to convey the proppant (or other solids) to a mixer 106. An example arrangement for proppant storage assembly 102 and mixer 106 will be discussed in more detail in reference to FIG. 2. In many systems, proppant storage assembly 102 will be configured such that the proppant will be delivered to a generally upper location of mixer 106, and through a passageway that is formed of a closed tube or similar structure, which extends to a point of entry into mixer 106.

Mixer 106 differs from prior mixers in being a closed container so as to retain particulates within the mixer. Mixer 106 can be configured for implementation in a number of different ways. In the example configuration, mixer 106 is configured to mix the proppant (which may be sand, as is commonly used; or may be any of other forms of proppant) with liquid and/or another fluid to form a dense, fluidized proppant mixture (generally referred to in the industry as “liquid sand,” because the initial implementations of this product have been using sand as the proppant therein. The term “liquid sand” is used herein to identify a relatively dense (or viscous) mixture of fluid with sand or any other proppant therein). The liquid sand may be pumped and has properties consistent with facilitating desirable mixing characteristics within the in-line mixer, which in this example system is a static in-line mixer 110. Viscosities of fluids used in this application may be any viscosity sufficient to carry the proppants into the fracture. In some cases, especially where the proppants are of lighter densities, the fluid used to form the fluidized proppant mixture can be water, but in most cases other fluids that are better suited to support the proppants has to be utilized, such as gels, etc.

In some example systems it may be desirable for the fluidized proppant mixture to be fluidized with a gel or a similar fluid, as is known for use in fracturing operations. In such operations, either an already-mixed gel the fluid may be introduced through a fluid inlet 118 in place of water; or water may be introduced through fluid inlet 118, and one or more additives (including, for example, a gel precursor), may be introduced through other inlets for fluid or solids, 120, 122, to be mixed within mixer 106 to form the gel.

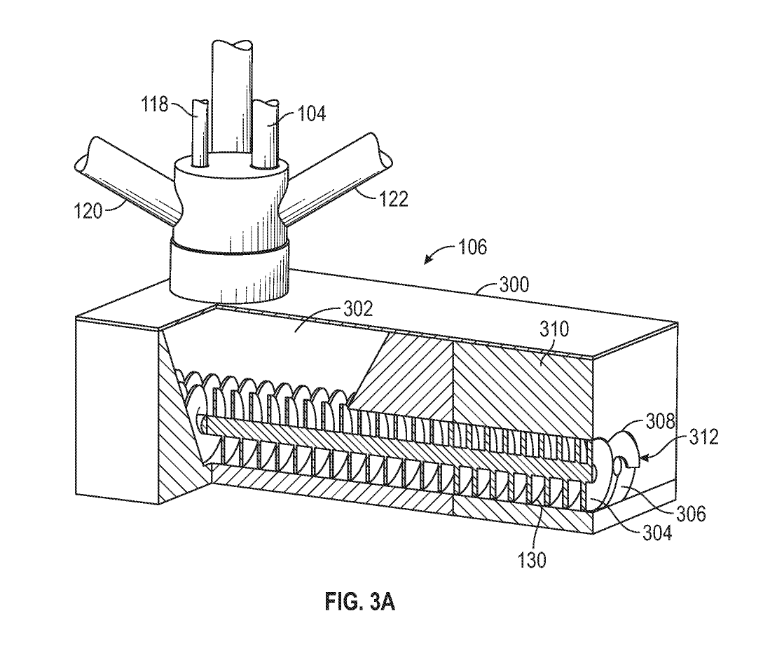

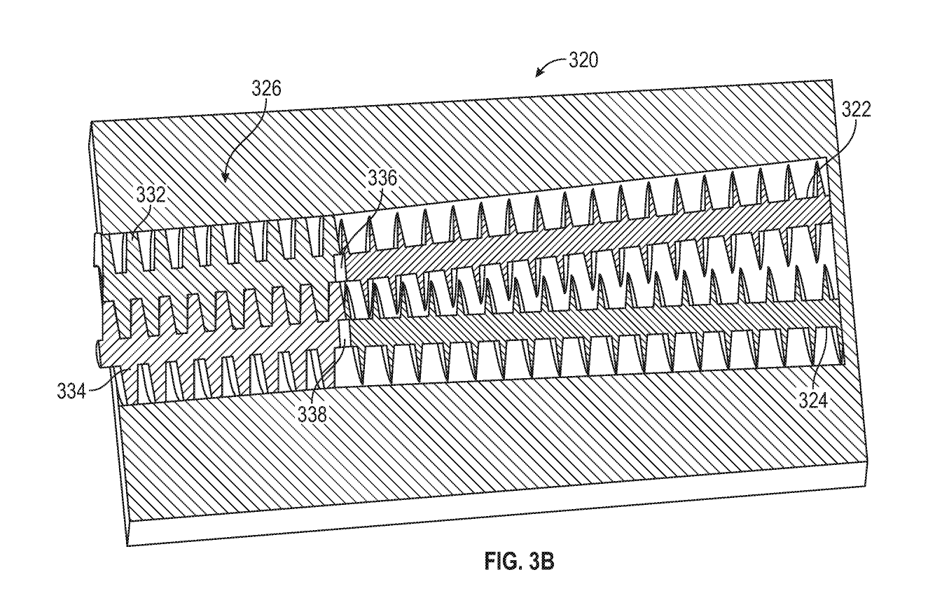

Mixer 106, in the present example system includes a mixing mechanism functional for mixing the proppant and one or more fluids, and potentially any other additives to form the described fluidized proppant mixture. Many types of mixing mechanisms may be contemplated, including, without limitation: one or more impeller blades rotating within the mixer, fluid jets (either air or liquid), other rotating structures to cause mixing, etc. In the depicted example, the mixing mechanism 130 includes at least one auger rotating partially within a defined passage within mixer 106. As will be discussed in more detail in reference to FIG. 3, in the described example, mixer 106 will include at least two augers extending in parallel relation to one another, with the blades of the augers interleaved with one another, and with the augers rotating in opposite directions relative to one another. The outlet of mixer 106 will communicate through a conduit to a pump bank 108 for pumping the fluidized proppant mixture to an in-line static mixer 110. Depending upon the delivery needs and other characteristics of the specific operation, the pump bank 108 may include a single pump, or may include multiple pumps which receive the fluidized proppant mixture, either in parallel or sequentially, and pump the fluidized proppant mixture to in-line mixer 110. As discussed in reference to FIG. 2, in some embodiments the pump bank 108 may be in the form of a single pump which is combined with the mixer 106 in a single unit.

The remaining fluid that will be used to form the fracturing slurry, which will often be a proppant-free or “clean fluid,” will be delivered to static mixer 110 through a separate supply line 126. In most circumstances, the clean fluid will provide the bulk of the volume of the fracturing slurry, and therefore will typically be supplied through use of a pump bank having multiple individual pumps arranged and interconnected to provide the volume and pressures needed for the fracturing operation and the proppant delivery. In some example systems, this remaining fluid used to form the fracturing slurry may not be pure fluid, but may include one or more solids, which may, in different examples, be different additives, such as, by way of example only, fibers (either degradable or non-degradable), another proppant different from the proppant provided from the mixer 106, other solids, etc. In such cases, an additional static mixer 134 may be added between the pump bank 112 and the previously identified static mixer 110. In some examples, such as that depicted, this additional static mixer 134 will again be an in-line mixer, such as any of the configurations referenced herein. In that configuration, proppant may be introduced (either alone or in a fluidized form) through an inlet 136 into this additional static mixer 134.

The in-line mixer 110 is preferably either coupled directly to the wellhead fitment (the wellhead “tree” or “Christmas tree”), or to another component coupled thereto. Persons skilled in the art will understand that the wellhead fitment known as the “tree” or “Christmas tree” is the fitment of valves, spools, and fittings used at the wellhead. In some configurations the in-line mixer may be generally near, but not in essentially direct contact with the wellhead fitment. For purposes of the present description, applicant will use the description of in-line mixer 110 being “coupled directly” to the wellhead; with the express definition that in this context, “coupled directly” means that the in-line mixer is coupled to the wellhead fitment either directly or with one or more conduits or valves between the mixer and the wellhead fitment, but with no pumps or reservoirs located between the mixer and the wellhead fitment. Thus, under this definition of the term “coupled directly” mix fluids will flow from in-line mixer 110 into the wellhead fitment, either directly or through one or more conduits or valves; but no pumps will be located in line after the in-line mixer and before the wellhead fitment. As a result, in-line mixer 110 is construed to be “coupled directly” to the wellhead fitment whether it directly physically engages the fitment, or an assembly associated therewith or whether it is placed some distance from the wellhead fitment, so long as there are no pumps or reservoirs located between the in-line mixer and the wellhead fitment.

A particular advantage of the described structure is that only pump bank 108 is used to pressurize and transfer the abrasive fluidized proppant slurry; and the majority of the pumps (i.e. those in pump bank 112), are isolated from the proppant. Thus, the majority of the pumps are protected from the potential damage from the fluidized proppant mixture. The isolation of the proppant to being pressurized and transported by pump bank 108, which is “coupled directly” to the wellhead fitment is consistent with the described allocation between the fluidized proppant and the clean fluid in that the pressurization of the fluid is already achieved before the in-line mixer, and thus there is no need for additional pumping or storage before mixed fracturing slurry from in-line mixer 110 reaches the wellhead fitment 116.

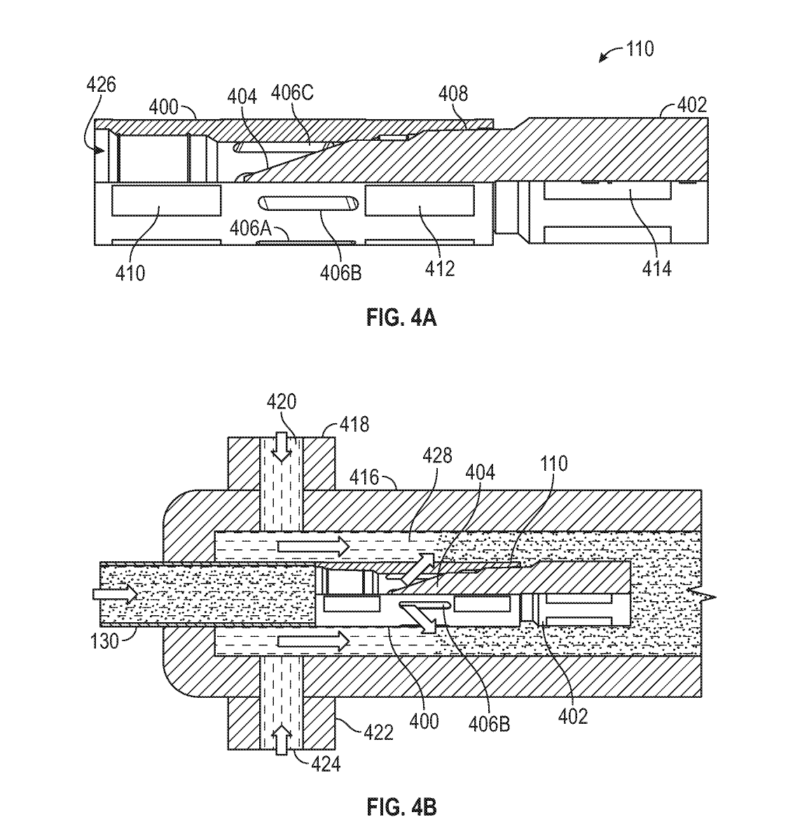

In-line mixer 110 will preferably be an in-line static mixer, achieving the mixing functionality with no additional moving parts. While use of a static mixer is not required, it is considered desirable because moving parts in a mixer would be subjected to both the pressures and the full volume of proppant-containing fluids being introduced into the well, and thus would be more susceptible to failure than a static mixer. One example advantageous configuration for an in-line static mixer is discussed herein in reference to FIG. 4. It should be understood that other forms of in-line mixers may be utilized; and in some cases “inline mixers” could just be pipe connections, tees, etc., with different branches of the connections being coupled to different sources of fluids, fluidized solids (such as “liquid sand”), or solids. The example configuration discussed in reference to FIG. 4, however, is designed to provide more effective and thorough mixing than would typically be expected with such rudimentary mixers formed through pipe connections and tees.

Referring now to FIG. 2, the figure depicts an example proppant storage and mixing assembly 200, as schematically represented in FIG. 1 (. Proppant storage and mixing assembly 200, in this example is configured to accommodate three proppant storage bins 202, 204 and 206, each supported in an elevated position on a support frame 208. Support of the three proppant storage bins 202, 204 and 206, at an elevated position allows emptying of each been through a respective dump conduit 210, 212, and 214, and into a receiving manifold 216 at the top of a mixing assembly 218. While the use of multiple storage bins 202, 204 and 206, to store proppant will be suitable for many operations, in some operations one or more of the storage bins 202, 204 and 206, may be used to store other solids. For example, one storage bin might be used to store fibers, shells, or other solid additives; and another storage bin might be utilized to store other solids used as an additive in the fracturing slurry.

In many example systems, each dump conduit 210, 212, and 214 will be cooperatively configured with receiving manifold 216 to provide a completely enclosed path from the storage bins 202, 204, 206 into mixing assembly 218. Proppant storage and mixing assembly 200 may include one or more motors and related control equipment to control release of proppant or other solids from each of the three storage bins 202, 204, and 206.

It should be understood that the depicted and described arrangement of mixing assembly 218 located directly beneath the multiple storage bins is one desirable configuration, but other configurations may also be utilized. For example, in other example systems, the proppant and/or other solid additives can be conveyed from storage bins 202, 204, 206 through a series of conduits and into a conveyor which will be configured to transport the proppant to a mixing assembly. In such systems, the exit conveyor may include an auger or similar mechanism to mechanically lift the proppant and/or other solids. To enter the mixing assembly.

As noted above, in the depicted example receiving manifold 216 is a closed assembly that each of dump conduits 202, 204 and 206 empty into. Thus, the transition from each of dump conduit 202, 204 and 206 to receiving manifold 216 is completely enclosed and dust and other particulates from the proppant and other solids cannot escape at that transition. Additionally, in many examples, each storage bin 202, 204, 206 will have a closed top thereby further preventing the release of dust or other particulates.

Referring now to FIG. 3A, that figure is a side view, partially sectioned vertically, of mixer 106 of FIG. 1. Mixer 106 includes a tank enclosure 300 defining a mixing area 302. Mixing area 302 terminates in a lower portion in a mixing region defined by a pair of augers 304 and 306 that extend partially within a defining passageway 308 formed within mixer 106. In the depicted example, augers 304 and 306 instead extend in parallel relation to one another, with the helical blades interleaved with one another, with the helix of each auger 304, 306 having a reversed direction relative to the other auger 304, 306. Additionally, in some examples, augers 304 and 306 will rotate in opposite directions from one another which, in combination with the interleaved blades will serve to enhance the mixing while also facilitating the movement of fluids toward the exit 312 of mixer 106. As described in reference to FIG. 1, the proppant will be delivered from exit conveyor 222 through conduit 104 and into mixer 106. Also as noted relative to FIG. 1, water, or another fluid will be introduced into mixer through inlet 118, and additional optional inlets 120, 122 are provided to facilitate introduction of other additives, either liquid or solid, four mixing in mixer 106. Mixer 106 will also include suitable controls and a drive system (not illustrated) for causing the described rotation of augers 304 and 306.

In addition to performing the mixing function, mixing assembly 106 further includes a pump section 310. Pump section 310 forms a positive displacement pump through extensions of the identified augers 304, 306. In the pump section, the blades of each auger are thickened relative to their form in the mixing section. In many examples, the auger blades will be thickened sufficiently to closely engage one another to form a positive displacement pump. In some examples, the augers will be rubber coated, at least in pump section 310 to provide better dimensional tolerance.

Referring now to FIG. 3B, as noted above, in the example of FIG. 3A, augers 304 and 306 extend generally in parallel with one another. FIG. 3B depicts an alternate configuration 320 for the auger portion of mixing assembly 106. In this alternate configuration for the auger portion 320, augers 322 and 324 will each include upper sections 328 and 330, respectively, that extend in non-parallel relation to one another, angling together increase the interleaving in the direction of travel of material in response to movement of the augers (i.e., in the direction moving toward the pump section 326). In this configuration, the augers 322, 324 will include lower sections 332 and 334, respectively, which still extend in parallel relation to one another in pump section 326. To configure rate this structure, the upper section of each auger 328, 330 will be coupled to the respective lower section 332, 334 through a flexible coupling 336, 338 that allows the rotation of the non-parallel sections to be converted to the parallel rotation in pump section 326. The flexible couplings can be of any suitable type, such as a universal joint, or other structures as will be apparent to persons skilled in the art having the benefit of this disclosure.

Referring now to FIGS. 4A-B, those figures depict in a side and partially vertical section view, and FIG. 4A an in-line mixer 110 suitable for use in the system as depicted in FIG. 1; and FIG. 4B depicts in-line mixer 110 in place within a conduit housing. Referring first to FIG. 4A, in-line mixer 110 includes an upper housing 400 and a lower housing 402, which are threadably coupled together at a threaded coupling 408. Communication is provided from the interior of upper housing 400 to the exterior through a plurality of elongated openings 406A-C in upper housing 400. Although only three elongated openings 406A-C are visible in FIG. 4A, in many examples at least four, six or even more elongated openings may be provided for communicating fluid within the upper housing to the exterior thereof. Lower housing 402 includes a conical portion 404 which access a flow splitter, to direct fluid flow within the interior of upper housing 400 outwardly through elongated openings 406A-C. As can be seen in the referenced figure, when lower housing 402 is fully threadably engaged with upper housing 401, the conical portion 404 extends with the taper upwardly from approximately the level of the lower extent of the elongated openings, thereby causing the fluid entering upper housing 401 through inlet end 426 to be forced radially outwardly through the elongated openings.

Referring now also to FIG. 4B, in-line mixer 110 is located within a conduit housing 416 which facilitates coupling of in-line mixer 110 to a wellhead fitment or similar structure, and facilitates the coupling of fluid conduits such as depicted at 126 and 130 in FIG. 1. Conduit housing 416 provides two or more fitments 418, 422 facilitating attachment to a clean fluid supply line such as 126 in FIG. 1. Additional fitment may supplied of it is determined preferable to introduce the clean fluid from additional radial locations around conduit housing 416.

As can be seen from the figure, with the clean fluid introduced in the annulus 428 in conduit housing 416 surrounding in-line mixer 110, as the fluidized proppant is forced to flow radially outwardly through the elongated openings, it mixes with the flow of clean fluid to form the fracturing slurry which is then directed down the wellbore.

The following numbered examples are illustrative embodiments in accordance with various aspects of the present disclosure:

1. A system for conveying proppant into a well, including a first in-line mixer located at the Earth's surface, the in-line mixer including a first fluid inlet and a second fluid inlet, and a fluid outlet, with the fluid outlet coupled directly to a wellhead tree; a fluid delivery system coupled to provide a supply of a first fluid to the first fluid inlet of the in-line mixer; and a proppant delivery system coupled to provide a fluidized proppant mixture to the second fluid inlet of the in-line mixer, wherein the proppant delivery system includes an enclosed proppant mixer assembly coupled to a supply of proppant and a supply of at least one fluid, and having at least one mixing mechanism operable to mix the supplied proppant with the supplied fluid to form the fluidized proppant mixture.
2. The system of example 1, in which the first in-line mixer comprises a central conduit and an outer conduit extending concentrically relative to the central conduit, and wherein the central conduit is in communication with the outer conduit through a plurality of radially extending apertures in the structure defining the central conduit.
3. The system of either of examples 1 or 2, wherein the first fluid is a proppant-free fluid.
4. The system of either of examples 1 or 2, wherein the first fluid contains a first solid additive which is different from the proppant in the fluidized proppant mixture provided at the second fluid inlet of the in-line mixer.
5. The system of any of examples 1, 2, or 4, wherein the first solid additive in the first fluid is a different proppant from the proppant in the fluidized proppant mixture
6. The system of any of examples 1-5, further comprising a second in-line mixer, the second in-line mixer coupled to the first fluid inlet of the first in-line mixer.
7. The system of claim any of examples 1-6, wherein the first fluid inlet of the first in-line mixer extends to the outer conduit; and wherein the second fluid inlet of the in-line mixer extends to the central conduit.
8. The system of any of examples 1-7, wherein the proppant delivery system further includes a pump coupled to receive the fluidized proppant mixture from the enclosed mixer assembly and pump the fluidized proppant mixture into the second fluid inlet of the first in-line mixer.
9. The system of any of examples 1-8, wherein the fluid delivery system to provide the first fluid comprising proppant-free fluids comprises a plurality of pumps.
10. The system of any of examples 1-9, wherein the proppant delivery system further comprises a closed passageway between a proppant reservoir and the proppant mixer assembly.
11. The system of any of the preceding examples, comprising: an in-line mixer located at the Earth's surface and coupled directly to a wellhead tree of a well; a proppant delivery circuit coupled to transport proppant through an enclosed passageway to an in-line mixer located at the Earth's surface, the proppant delivery circuit including: an enclosed proppant mixer coupled to receive proppant and at least one fluid, and having a mixing mechanism to mix the fluid and proppant to form a fluidized proppant mixture, and a first pump coupled between the enclosed proppant mixer and the in-line mixer, and operable to pump the fluidized proppant mixture to the in-line mixer; a fluid delivery circuit coupled to transport proppant-free fracturing fluids to the in-line mixer, the fluid delivery circuit including at least a second pump that is separate from the first pump, and is placed upstream of the in-line mixer.
12. The proppant delivery system of any of the preceding examples, wherein the mixing mechanism comprises at least one driven impeller placed and shaped to promote mixing of the proppant and at least one fluid to form the fluidized proppant mixture.
13. The system of any of the preceding examples, wherein the mixing mechanism comprises at least one auger.
14. The system of any of the preceding examples, wherein the mixing mechanism comprises at least two augers; and wherein a first auger rotates in a counter direction relative to a second auger.
15. The system of any of the preceding examples, wherein the second pump of the fluid delivery circuit comprises a bank of pumps.
16. The system of any of the preceding examples, wherein the enclosed proppant mixer comprises: a proppant inlet forming a portion of the enclosed passageway; and a fluid inlet coupled to receive the fluid used to form the fluidized proppant mixture.
17. A method of supplying a fracturing fluid including proppant to a well, comprising: an in-line mixer located at the Earth's surface and coupled directly to a wellhead tree of a well; receiving proppant from a proppant container and transporting the received proppant through an enclosed conveyance system to an enclosed proppant mixer; mixing the proppant with a fluid in the enclosed proppant mixer, the proppant mixer having a mixing mechanism to mix the fluid and proppant to form a fluidized proppant mixture; using a first pump to pump the fluidized proppant mixture to an in-line mixer that is located at the Earth's surface and coupled directly to a valve tree at the wellhead; and using a pump bank, separate from the first pump, to deliver proppant-free fracturing fluids to the in-line mixer.
18. The method of example 17, wherein the in-line mixer comprises a central conduit and an outer conduit extending concentrically relative to the central conduit, and wherein the central conduit is in communication with the outer conduit through a plurality of radially extending apertures in the structure defining the central conduit.
19. The method of either of examples 17 and 18, further comprising delivering the fluidized proppant mixture from the pump to the central conduit of the in-line mixer; and delivering the proppant-free fracturing fluids to the outer conduit of the in-line mixer.
20. The method of any of examples 17-19, wherein the first pump is formed as a single unit with the proppant mixer.
21. The method of any of examples 17-20, which are performed through use of a system in accordance with any of examples 1-16.
22. A method of operating any of the systems of examples 1-16 to supply a fracturing fluid including proppant into a well.

Many variations may be made in the structures and techniques described and illustrated herein without departing from the scope of the inventive subject matter. Accordingly, the scope of the inventive subject matter is to be determined by the scope of the following claims and all additional claims supported by the present disclosure, and all equivalents of such claims.

We claim:

1. A system for conveying proppant into a well, comprising:
a first in-line mixer located at the Earth's surface, the in-line mixer including a first fluid inlet and a second fluid inlet, and a fluid outlet, with the fluid outlet coupled directly to a wellhead tree;
a fluid delivery system coupled to provide a supply of a first fluid to the first fluid inlet of the in-line mixer;
a proppant delivery system coupled to provide a fluidized proppant mixture to the second fluid inlet of the in-line mixer, wherein the proppant delivery system includes an enclosed proppant mixer assembly coupled to a supply of proppant and a supply of at least one fluid, and having at least one mixing mechanism operable to mix the supplied proppant with the supplied fluid to form the fluidized proppant mixture.

2. The system of claim 1, wherein the first in-line mixer comprises a central conduit and an outer conduit extending concentrically relative to the central conduit, and wherein the central conduit is in communication with the outer conduit through a plurality of radially extending apertures in the structure defining the central conduit.

3. The system of claim 1, wherein the first fluid is a proppant-free fluid.

4. The system of claim 1, wherein the first fluid contains a first solid additive which is different from the proppant in the fluidized proppant mixture provided at the second fluid inlet of the in-line mixer.

5. The system of claim 4, wherein the first solid additive in the first fluid is a different proppant from the proppant in the fluidized proppant mixture

6. The system of claim 4, further comprising a second in-line mixer, the second in-line mixer coupled to the first fluid inlet of the first in-line mixer.

7. The system of claim 2, wherein the first fluid inlet of the first in-line mixer extends to the outer conduit; and wherein the second fluid inlet of the in-line mixer extends to the central conduit.

8. The system of claim 1, wherein the proppant delivery system further includes a pump coupled to receive the fluidized proppant mixture from the enclosed mixer assembly and pump the fluidized proppant mixture into the second fluid inlet of the first in-line mixer.

9. The system of claim 3, wherein the fluid delivery system to provide the first fluid comprising proppant-free fluids comprises a plurality of pumps.

10. The system of claim 9, wherein the proppant delivery system further comprises a closed passageway between a proppant reservoir and the proppant mixer assembly.

11. A proppant delivery system, comprising:
an in-line mixer located at the Earth's surface and coupled directly to a wellhead tree of a well;
a proppant delivery circuit coupled to transport proppant through an enclosed passageway to an in-line mixer located at the Earth's surface, the proppant delivery circuit including,
an enclosed proppant mixer coupled to receive proppant and at least one fluid, and having a mixing mechanism to mix the fluid and proppant to form a fluidized proppant mixture, and
a first pump coupled between the enclosed proppant mixer and the in-line mixer, and operable to pump the fluidized proppant mixture to the in-line mixer;
a fluid delivery circuit coupled to transport proppant-free fracturing fluids to the in-line mixer, the fluid delivery circuit including at least a second pump that is separate from the first pump, and is placed upstream of the in-line mixer.

12. The proppant delivery system of claim 11, wherein the mixing mechanism comprises at least one driven impeller placed and shaped to promote mixing of the proppant and at least one fluid to form the fluidized proppant mixture.

13. The proppant delivery system of claim 12, wherein the mixing mechanism comprises at least one auger.

14. The proppant delivery system of claim 13, wherein the mixing mechanism comprises at least two augers; and wherein a first auger rotates in a counter direction relative to a second auger.

15. The proppant delivery system of claim 11, wherein the second pump of the fluid delivery circuit comprises a bank of pumps.

16. The proppant delivery system of claim 11, wherein the enclosed proppant mixer comprises:
a proppant inlet forming a portion of the enclosed passageway; and
a fluid inlet coupled to receive the fluid used to form the fluidized proppant mixture.

17. A method of supplying a fracturing fluid including proppant to a well, comprising:
an in-line mixer located at the Earth's surface and coupled directly to a wellhead tree of a well;
receiving proppant from a proppant container and transporting the received proppant through an enclosed conveyance system to an enclosed proppant mixer;
mixing the proppant with a fluid in the enclosed proppant mixer, the proppant mixer having a mixing mechanism to mix the fluid and proppant to form a fluidized proppant mixture;
using a first pump to pump the fluidized proppant mixture to an in-line mixer that is located at the Earth's surface and coupled directly to a valve tree at the wellhead; and
using a pump bank, separate from the first pump, to deliver proppant-free fracturing fluids to the in-line mixer.

18. The method of claim 17, wherein the in-line mixer comprises a central conduit and an outer conduit extending concentrically relative to the central conduit, and wherein the central conduit is in communication with the outer conduit through a plurality of radially extending apertures in the structure defining the central conduit.

19. The method of claim 18, further comprising delivering the fluidized proppant mixture from the pump to the central conduit of the in-line mixer; and delivering the proppant-free fracturing fluids to the outer conduit of the in-line mixer.

20. The method of claim 17, wherein the first pump is formed as a single unit with the proppant mixer.
